(19) United States
(12) Patent Application Publication
(10) Pub. No.: US 2021/0400423 A1
(43) Pub. Date: Dec. 23, 2021

(54) GENERATION AND MODIFICATION OF LOCATIONAL ENTRIES AND GEOFENCES FOR SAFETY OF GROUP MEMBERS

(71) Applicant: Microsoft Technology Licensing, LLC, Redmond, WA (US)

(72) Inventors: Rahul Anantha Padmanabha Udipi, Cupertino, CA (US); Ryan Pedram Khademi, Seattle, WA (US); Leah Elizabeth Shin, Everett, WA (US)

(21) Appl. No.: 16/908,302

(22) Filed: Jun. 22, 2020

(51) Int. Cl. H04W 4/021; H04W 4/029; H04W 4/02; H04L 29/08

(52) U.S. Cl. CPC H04W 4/021; H04L 67/18; H04W 4/023; H04W 4/029

(57) ABSTRACT

In non-limiting examples of the present disclosure, systems, methods and devices for creating and modifying safe zones provided. Safe zones associated with members of a group monitored by a group device monitoring service may be manually or automatically created. A safe zone may be created by adding an approved locational entry to a location control list for a user account. An approved locational entry may comprise an identity of a location, geofence boundaries for a location, and/or time and/or day of the week information when a user is approved for visiting a location. A dependent locational entry may be added to a location control list. A dependent locational entry may comprise an identity of a location and a condition that must be fulfilled before the dependent locational entry may be transformed to an approved locational entry.

### BACKGROUND

It has become commonplace for each member of a family to have her own smart phone and/or other computing device (e.g., tablet, smart watch) so that family members can easily communicate with one another. Family members frequently track one another with device tracking software that is integrated in those computing devices. However, this can lead to group members, and especially children, feeling like their privacy is not respected and that they are not trusted.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for creating and modifying safe zones and their geofences for group members of a group device monitoring service. A group device monitoring service may be associated with a group of user accounts that include administrator user accounts (e.g., adult user accounts) and secondary user accounts (e.g., child user accounts). Administrator users associated with the administrator user accounts may create safe zones where the secondary users associated with the secondary user accounts are approved to visit. Each secondary user account may be associated with a location control list that includes each of the safe zones that the secondary user is approved to visit. A safe zone may be included in a location control list as an approved locational entry. An approved locational entry may comprise a location, a geofence, a time, and/or day of the week when the secondary user is approved to visit the corresponding location. In some examples, a safe zone may be automatically created based on a secondary user visiting a location a threshold number of times and/or with a threshold frequency. In additional examples, a safe zone may be manually created and associated with a secondary user account by an administrator user.

In examples, the group device monitoring service may only provide specific locational information about secondary users to administrator users if those secondary users are outside a geofence for a safe zone. Alternatively, if a secondary user is within a geofence for a safe zone, and an administrator user checks the location of the secondary user in a group device monitoring service application, the group device monitoring service may simply provide a generic indication that the secondary user is within a safe zone.

In some examples, an administrator user may encourage a secondary user to explore a new location by adding a dependent locational entry to a location control list. A dependent locational entry may include one or more conditions that must be fulfilled before the dependent locational entry is transformed into an approved locational entry. For example, a secondary user may have to upload a digital image taken by the secondary user's device, with a geotag from the location, to a group device monitoring service application in order to transform a dependent locational entry for that location to an approved locational entry. In this manner, a secondary user's safe zones may be expanded as a gamified experience.

### BRIEF DESCRIPTION OF THE DRAWINGS

Non-limiting and non-exhaustive examples are described with reference to the following figures:

FIG. 1 is a schematic diagram illustrating an example distributed computing environment for surfacing locational information and alerts in relation to safe zones for a group associated with a group device monitoring service.

FIG. 2 illustrates a simplified block diagram of a location control list associated with a user account managed by a group device management service.

FIG. 3 illustrates a simplified block diagram of a computing environment for transforming a dependent locational entry to an approved locational entry of a location control list upon the fulfillment of a locational visitation condition.

FIG. 4 illustrates a computing environment for creating a new safe zone and geofence utilizing a manual boundary tracing mechanism.

FIG. 5 illustrates a computing environment for creating a new safe zone and geofence utilizing a manual radial expansion mechanism.

FIG. 6 illustrates a simplified block diagram for processing natural language from a software application to identify new location events.

FIG. 7 is an exemplary method for modifying user account locational boundaries.

FIG. 8 is another exemplary method for modifying user account locational boundaries.

FIGS. 9 and 10 are simplified diagrams of a mobile computing device with which aspects of the disclosure may be practiced.

FIG. 11 is a block diagram illustrating example physical components of a computing device with which aspects of the disclosure may be practiced.

FIG. 12 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Non-limiting examples of the present disclosure describe systems, methods and devices for creating and modifying safe zones for group members of a group device monitoring service. As described herein, a safe zone may comprise a location and/or a geofence surrounding a location, that a user has been approved to visit. A safe zone may comprise an approved entry in an action control list that is monitored by a group device monitoring service.

The group device monitoring service may associate a plurality of user accounts and computing devices with one another. For example, a first user account may create a group with the group device monitoring service. The group may comprise a plurality of user accounts and a plurality of computing devices. The first user account may be designated by the group device monitoring service as an administrator user account. The administrator user account may have administrative controls and permissions in relation one or more secondary user accounts for the group. The administrative controls and permissions may relate to device usage, application usage, device location, safe zone creation, and/or safe zone modification. In some examples, the administrator user account may designate one or more user accounts of the group as co-administrator accounts that also have administrative controls and permissions in relation to one or more secondary user accounts for the group.

The group device monitoring service may provide locational information about computing devices associated with one or more other user accounts of a group to an administrator user account of the group. In some examples, the administrator user account may allow secondary user accounts to receive locational information about administrator computing devices. The group device monitoring service may maintain a location control list for each user account of a group. A location control list may include identities (e.g., names, location types) and geolocation coordinates for locations that are approved for a user to be at. In some examples, a location control list may associate times, days of the week, and/or dates with the locations in a location control list. Those times, days of the week, and/or dates may be approved temporal parameters for a user of a group to visit those locations and/or they may comprise temporal patterns when a user of a group typically visits those locations.

Approved locational entries may be added to a location control list manually or automatically. For example, an administrator user may manually add an approved locational entry to a location control list for a secondary user. An approved locational entry may be added automatically to an action control list if, for example, a secondary user visits a new location a threshold number of times and/or with a threshold frequency. In additional examples, if a secondary user visits a new location a threshold number of times and/or with a threshold frequency, an administrator user may be prompted to approve the location and/or a time or day of the week associated with the secondary user visiting the location as a new location entry for the secondary user's location control list. In some examples, the group device monitoring service may process user data (e.g., text messages, emails, etc.) with one or more machine learning models to determine whether a secondary user is likely going to visit a new location that is not included as an approved locational entry of a location control list. If such a determination is made, the group device monitoring service may prompt an administrator user to approve the location and/or a time or day of the week associated with the secondary user visiting the location as a new location entry for the secondary user's location control list.

In some examples, the group device monitoring service may receive locational information for computing devices associated with a group. The group device monitoring service may determine whether geolocation coordinates for a computing device associated with a group user account match a locational entry included in a location control list for that user account. In some examples, the group device monitoring service may also determine whether a time, day of the week, and/or date corresponding to the time the computing device is at a location is included in the location control list for that specific locational entry.

In some examples, a locational entry in a location control list may be associated with a geofence. A geofence for a locational entry may comprise the boundary for a safe zone. In some examples, if a secondary user approaches the boundary of a geofence for a safe zone from the inside, a boundary alert/notification may be sent to a secondary user account associated with the secondary user that indicates that the secondary user is approaching the geofence boundary. In additional examples, if a secondary user is outside of the geofence for each safe zone/approved locational entry in a location control list, the group device monitoring service may notify an administrator user of the secondary user's location. Alternatively, if a secondary user is inside a geofence for a safe zone/approved locational entry, the device monitoring service may only provide an indication to the administrator user that the secondary user is in a safe zone, without specifying the secondary user's exact location.

In some examples, an administrator user may add dependent locational entries to a location control list for a secondary user. A dependent locational entry may have one or more conditions associated with it. If those one or more conditions are satisfied, the dependent locational entry may be transformed into an approved locational entry of the location control list. Examples of conditions that may be associated with a dependent locational entry may include: a condition that a secondary user send an image and/or video from a location corresponding to the dependent locational entry to an administrator user (e.g., upload an image taken at the location to a group device monitoring service application); a condition that a secondary user send an image and/or video with a geotag for the location corresponding to the dependent locational entry to an administrator user; and/or a condition that a secondary user visit a location a threshold number of times and/or at certain times or days. In some examples, a condition may specify that a user must send an image of an object at a location to an administrator user prior to the corresponding dependent locational entry being transformed to an approved locational entry. One or more image neural networks may process an image to determine whether a specific object corresponding to a condition of a dependent locational entry is included in an image.

The systems, methods, and devices described herein provide technical advantages for creating and modifying locational boundaries for group members. Secondary users (e.g., child members) of device groups that are monitored by administrator users (e.g., parent users) of a group device monitoring service typically do not enjoy feeling like they are being tracked everywhere they are going with their mobile computing devices. The systems, methods, and device described herein provide secondary users with more autonomy in that exact locations may not be provided to administrator users when the secondary users are within safe zones. Further, the user experience associated with adding new safe zones to explore are enhanced via the mechanisms described herein in that administrator users can encourage secondary users to explore new areas through the use of dependent locational entries, which may be transformed to approved locational entries upon fulfillment of one or more conditions. Processing costs associated with administrator users having to use text messaging and phone calls to determine whether secondary users are within safe zones are also reduced by providing automated tracking services via the mechanisms described herein.

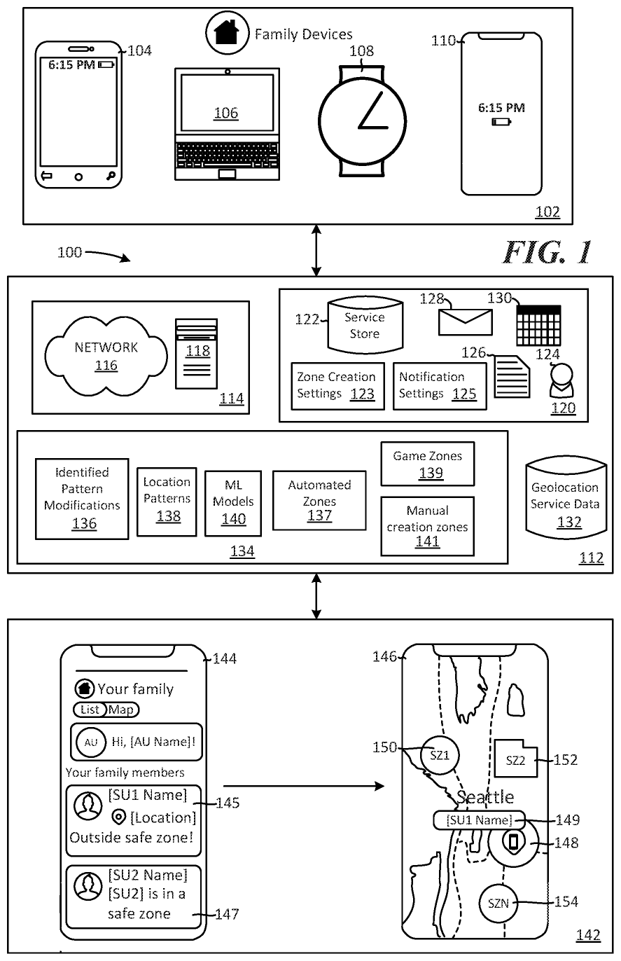

FIG. 1 is a schematic diagram illustrating an example distributed computing environment 100 for surfacing locational information and alerts in relation to safe zones for a group associated with a group device monitoring service. Computing environment 100 includes family devices sub-environment 102, group monitoring service sub-environment 112, and group member information sub-environment 142.

Family devices sub-environment 102 includes tablet computing device 104, laptop computing device 106, smartwatch computing device 108, and smartphone computing device 110. In this example, each of the devices illustrated in family devices sub-environment 102 belong to members of a family and are associated with a group device monitoring service via a family account. However, it should be understood that computing devices may be associated with the group device monitoring service via a generic group account and devices need not necessarily be associated with family members.

Group monitoring service sub-environment 112 includes network and processing sub-environment 114, service store sub-environment 120, geolocation service data store 132, and group device monitoring elements 134. Network and processing sub-environment 114 includes network 116, via which any and all of the computing devices described herein may communicate with one another, and server computing device 118. Server computing device 118 is illustrative of one or more server computing devices that may host a group device monitoring service.

The group device monitoring service may be associated with a group. The group may include a plurality of user accounts, and each of the plurality of user accounts may be associated with one or more computing devices. The group may include one or more administrator accounts and one or more secondary accounts. In some examples, the administrator accounts may be associated with parent users of a family group, and the secondary accounts may be associated with child users of a family group. The administrator accounts may control settings which approve or deny locations that secondary account users may visit, times at which secondary account users may visit locations, days of the week that secondary account users may visit locations, and/or dates on which secondary account users may visit locations. That is, if a secondary account user is determined to be at a location that has not been approved, or a secondary account user is determined to be at a location that is approved, but the user is at the location at an unapproved time or day, the group device monitoring service may cause an alert to be surfaced on one or more computing devices associated with an administrator account.

In examples, one or more user accounts of a group may be associated with a location control list of the group device monitoring service. A location control list includes information about locations that group users are approved to visit. A location control list may be associated with one or more computing devices of a user account that the location control list relates to. For example, if a location control list relates to a first user account, that location control list may include identifying information (IP addresses, device IDs) for one or more computing devices associated with the first user account. A location control list may further include a plurality of location entries. A location entry for a location may include identifying information (e.g., location name, location type) for the location, geocoordinates for the location, geofence parameters for the location (e.g., radial boundary from central location, non-radial boundary from central location), times when a corresponding user is approved to be at the location, days when the corresponding user is approved to be at the location, and/or dates when the corresponding user is approved to be at the location.

An administrator user of a group may determine which locations, times, days, and dates are added to a location control list for a secondary user. In some examples, an administrator user may manually approve locations, times, days, and dates that are approved for a secondary user and that should therefore be associated with a location entry in the secondary user's location control list. In additional examples, an administrator user may be prompted to add or deny entry of a new location (or times associated with visiting the new location) to a location control list for a secondary user when the secondary user is determined to be at a location that is not already included in the secondary user's location control list or if the times associated with visiting an existing location are not included in the secondary user's location control list. In still additional examples, an administrator user may manually adjust a setting for a secondary user that allows the group device monitoring service to automatically add a new location, and/or times associated with visiting a new location, to a location control list for a secondary user if the secondary user has been determined to visit that location a threshold number of times and/or a threshold number of times at a specific time and/or day. In other examples, an administrator may manually adjust a setting for a secondary user that allows the group device monitoring service to automatically add a new location, and/or times associated with visiting a new location, to a location control list for a secondary user if the secondary user has been determined to visit that location with a threshold frequency (e.g., threshold number of times over X days, threshold number of times over Y weeks), and/or a threshold frequency at a specific time and/or day. In some examples, the group device monitoring service may automatically add a location entry for a new location to a location control list for a secondary user account if the group device monitoring service has provided an out of safe zone alert to an administrator user account and that alert has been dismissed one or more times.

In some examples, a secondary account user may be approved to be at any location while they are accompanied by an administrator account user of the same group. For example, although a location may not be included in a location control list for a secondary user account, and the secondary user associated with that secondary user account may be determined to be at that location, a safe zone alert may nonetheless not be surfaced if the secondary user is determined to be within a threshold distance of an administrator user of the group while at that location.

Service store sub-environment 120 may include information associated with the group device monitoring service and/or one or more productivity application services. For example, service store sub-environment may include one or more location control lists, one or more group identities and settings for a group monitored by the group device monitoring service, and/or content associated with one or more additional applications. This information may be saved in service store 122. In some examples, service store 122 may be associated with a plurality of user accounts, such as user account 124. User account 124 may be associated with a group monitored by the group device monitoring service. User account 124 may additionally or alternatively be associated with one or more productivity application services. In this example, user account 124 is associated with an email application service, a word processing application service, and a calendar application service. As such, service store 122 includes email messages 128 associated with user account 124, documents 126 associated with user account 124, and calendar information 130 associated with user account 124. Service store 122 may include additional information from one or more other applications, such as SMS messaging applications, group messaging/collaboration applications, task management applications, to-do list applications, map applications, reservation applications, presentation applications, and spreadsheet applications, for example.

Service store sub-environment 120 further includes zone creation settings 123 and notification settings 125, which may be associated with one or more user accounts in service store 122 that are monitored by the group device monitoring service. Zone creation settings 123 may comprise one or more modifiable rules for creating, modifying, and/or deleting one or more safe zones associated with a user account. The rules may be modified by an administrator account of a group. For example, a first rule may dictate a number of times or a specific frequency with which a secondary user must visit a location to automatically cause a safe zone (e.g., an approved location entry) corresponding to that location to be added to a location control list for the secondary user. A second rule may dictate a default radius for geofences when new approved location entries and/or dependent location entries are added to location control lists. Notification settings 125 may comprise one or more modifiable rules for adjusting when administrator accounts and/or secondary accounts may be notified when a member of a group is determined to be outside of a safe zone (e.g., outside of an approved location entry), when a member of a group is determined to be in a safe zone, and/or when a member of a group is determined to be approaching the boundary of a safe zone from the inside of a geofence corresponding to an approved location entry in a location control list.

Geolocation service data store 132 may include geolocation data associated with one or more parameters. For example, geolocation service data store 132 may include a list of geocoordinates, entities that are present at those geocoordinates, types of those entities, hours of operation for those entities, IP addresses associated with geocoordinates, boundaries associated with geocoordinates and locations, and/or geofences for specific areas included in the geocoordinates. In some examples, when a computing device associated with a group is active, the group device monitoring service may determine geolocation coordinates for a location where a computing device is currently active. Those coordinates may be provided to geolocation service data store 132, which may match the coordinates to one or more locations, entities, location types, and/or geofences. The geocoordinates for an active device may be identified via cellular data, GPS data, and/or WiFi data, for example.

Group device monitoring elements 134 include identified pattern modifications element 136, automated zones element 137, location patterns element 138, game zones element 139, machine learning models 140, and manual creation zones element 141. Location patterns element 138 may include locational history associated with one or more user accounts and presence at one or more locations. Identified pattern modifications element 136 may include locational history associated with user/device presence at one or more locations that are not included in a location control list for a user, but for which those locations have been approved based on analysis of one or more pieces of data. The one or more pieces of data may include calendar events associated with a user account of a group that includes the user account for the corresponding user, emails associated with a user account of a group that includes the user account for the corresponding user, and/or SMS messages for a user account of a group that includes the user account for the corresponding user, for example.

Machine learning models 140 may include one or more machine learning models that have been trained to identify one or more words or sentences (e.g., from calendar events, emails, SMS messages) that are relevant to a “visit location” intent. Machine learning models 140 may include one or more word and/or sentence embedding layers (e.g., Word2Vec, BERT, Sent2Vec, Embeddings from Language Models (ELMo), recurrent neural network). Machine learning models 140 may further include a sentence level information aggregation layer for aggregating embeddings from each word in a natural language input into a distinct embedding for one or more sentences included in a natural language input. The distinct sentence aggregation layer may apply a neural network to the embeddings for each word. In examples, the neural network may comprise a gated recurrent unit (GRU) neural network or bidirectional GRU (bi-GRU) neural network. In other examples the neural network may comprise a long short-term member (LSTM) neural network, an attention-based aggregation method, etc. Machine learning models 140 may further include a contextual aggregation layer for aggregating each distinct embedding for each of the sentences into a contextual embedding. In aggregating the distinct embeddings for each sentence, the contextual aggregation layer may apply a neural network to each distinct embedding for each of the sentences. In examples, the neural network may comprise a GRU neural network, or bi-GRU neural network. In other examples, the neural network may comprise an LSTM neural network, an attention-based aggregation method, etc. Machine learning models 140 may further comprise a scoring layer for scoring and ranking one or more sentences or one or more words based on their relevance to a visit location intent. In scoring and ranking one or more words, the scoring layer may apply a classifier function to an embedding (e.g., embeddings generated by the contextual aggregation layer). In examples, the classifier function may comprise a sigmoid function. Other activation functions (e.g., tanh, softplus) may be utilized for scoring an embedding.

Automated zones element 137 may apply one or more rules from zone creation settings 123 to information related to user location patterns (e.g., information from identified pattern modifications element 136, information from location patterns element 138) to automatically generate new locational entries that may or may not be atomically added as approved entries in a location control list. For example, automated zones element 137 may automatically generate a new locational entry, including a default geofence size/boundary, a location ID, and/or one or more time constraints, for a location that a secondary user has visited one or more times. In some examples, that new location may be automatically added as an approved locational entry to a location control list if the secondary user is determined to visit that location a threshold number of times and/or with a threshold frequency.

Game zones element 139 may comprise rules and/or settings for generating, modifying, and/or deleting dependent locational entries in association with a location control list. For example, an administrator user may add a new location entry to a location control list, create a geofence associated with that location, and set one or more condition types associated with that location and/or geofence that must be fulfilled for the location to be added as an approved entry to a location control list for a secondary user account. Examples of condition types that may be associated with a location may include: sending a digital image or video from the location to an administrator user, sending a digital image or video with a geotag matching the location to an administrator user, sending a digital image or video with a timestamp matching a time requirement to an administrator user, visiting the location a threshold number of times, and/or visiting the location at certain times, days of the week and/or dates, for example. The image or video may have to have a device ID associated with them that matches the sending/uploading user account.

Manual creation zones element 141 may comprise rules and/or settings for manually creating and adding new approved locational entries to a location control list. For example, an administrator user may utilize a name or geocoordinates associated with a location to add that location as an approved locational entry for a user's location control list. The user may create a geofence for a location utilizing a drawing/tracing feature of a group device monitoring service application, a radial expansion feature of the group device monitoring service application, and/or a default setting of the group device monitoring service application.

In this example, computing device 110 in family device sub-environment 102 is the same computing device as computing device 144 and computing device 146 in group member information sub-environment 142. Computing device 110 is associated with an administrator account of a group managed by the group device monitoring service. The administrator user is [AU Name]. Computing device 104, computing device 106, and computing device 108 may be associated with secondary users of the group managed by the group device monitoring service. In this example, a secondary user of the group has been identified as being currently located at a location that is not included in a locational entry (e.g., outside of a geofence for an approved locational entry) for a location control list for that user. For example, the secondary user may be wearing computing device 108, geocoordinates for computing device 108 may be identified, the geocoordinates may be matched to a location in geolocation service data store 132, and the identity of that location may not be included in any geofence in a location control list for the secondary user. As such, alert 145 may be caused to be displayed on computing device 144.

Alert 145 is surfaced in a group device monitoring service application (e.g., the “your family” application) executed all or in part by computing device 144. Alert 145 may be surfaced in a different manner (e.g., via a pop-up notification, in a different application, etc.). Alert 145 displays the name of the secondary user “[SU1 Name]”, the location where the secondary user has been identified as currently being located “[Location]”, and an indication that there is an anomaly detected (e.g., the secondary user is outside each geofence for approved locational entries in a location control list for the secondary user). In some examples, alert 145 may be automatically surfaced if/when a determination is made that the secondary user is outside a safe zone (e.g., outside a geofence for an approved location entry) for the secondary user.

In other examples, alert 145 may only be viewed when the “your family” application is navigated to a user location screen, such as is displayed on computing device 144. A user location screen may display the identities of one or more user accounts that are monitored by the group device monitoring service for a group, an identity of one or more safe zones that users are currently in, an indication that one or more users are currently in a safe zone, and/or an indication that one or more users are not in one or more safe zones. Thus, in this example, alert 145 is displayed in the user location screen, with an indication that secondary user [SU1 Name] is outside of the safe zones for that user account. Additionally, secondary user window 147 displays an indication that the secondary user [SU2 Name] is currently within a safe zone for that user account. That is, the group device monitoring service may display specific location data for user accounts (e.g., [SU1 Name]) that are determined to not be within a safe zone (e.g., not within a geofence for an approved location entry in a location control list for a corresponding user), and the group device monitoring service may display non-specific location data for user accounts (e.g., [SU2 Name]) that are determined to be within a safe zone (e.g., within a geofence for an approved location entry in a location control list for a corresponding user). Thus, the locational privacy is respected for users that stay within approved locational boundaries.

Computing device 144 also displays a selectable element for changing the user interface to a map view for the list view that is currently surfaced on computing device 144. In this example, the map view is illustrated by the display of computing device 146. Computing device 146 displays a map of a plurality of safe zones (e.g., locations with geofences that are included as approved location entries) for the secondary user [SU1 Name]. Those safe zones are safe zone one 150, safe zone two 152, and safe zone N 154. Computing device 146 does not display a current location of the second user [SU2 Name] because that second user is currently in a safe zone. However, computing device 146 displays a current location of a computing device associated with the second user [SU1 Name] because [SU1 Name] is not in a safe zone associated with that user account. Specifically, current location 148 is the approximate current location of [SU1 Name] as indicated by name element 149.

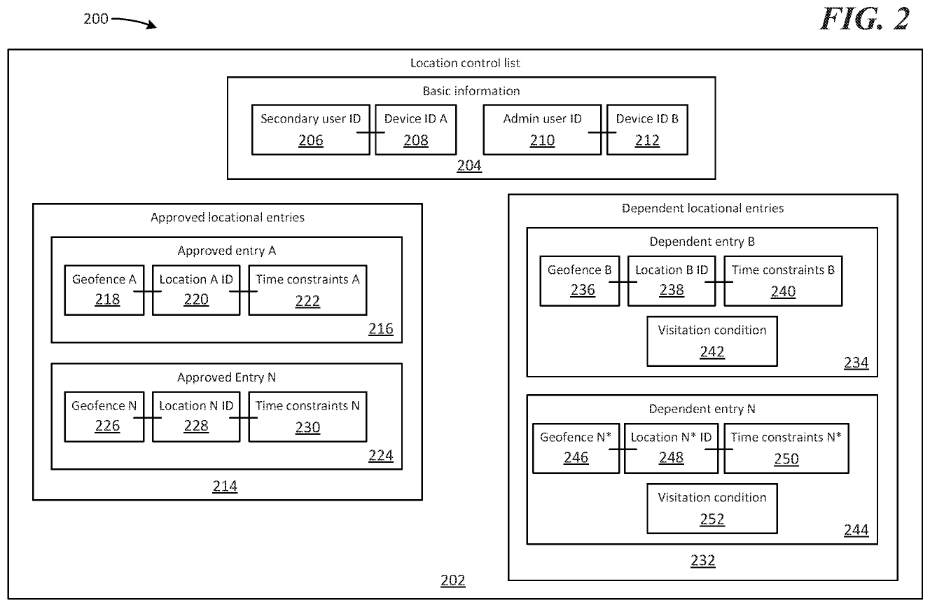

FIG. 2 illustrates a simplified block diagram 200 of a location control list 202 associated with a user account managed by a group device management service. Location control list 202 may include approved and/or dependent locational entries for one or more users. That is, an administrator user may create a location control list that includes locational entries, geofences, time constraints, and/or visitation conditions that apply to one or more users (e.g., secondary accounts). Location control list 202 includes basic information 204, approved locational entries 214, and dependent locational entries 232.

Basic information 204 includes an identity of a first user account (e.g., secondary user ID 206), and an identity of a first computing device (e.g., device ID A 208). Basic information 204 further includes an identity of a second user account (administrator user ID 210), and an identity of a second computing device (e.g., device ID B 212). The administrator user account associated with administrator user ID 210 may be an administrator user account of a group that includes a secondary user account corresponding to secondary user ID 206. That group may be monitored by the group device monitoring service.

Location control list 202 includes approved locational entries 214 and dependent locational entries 232. Approved locational entries 214 comprise information related to locations that the secondary user (e.g., secondary user ID 206) may visit while maintaining the locational privacy of the secondary user. That is, approved locational entries 214 correspond to safe zones for the secondary user that have been created by an administrator user account (e.g., administrator user ID 210), for which the administrator user account will not receive locational notifications for when the secondary user is within the geofences corresponding to those locational entries. Specifically, approved locational entries 214 includes approved entry A 216 and approved entry N 224. Approved entry A 216 comprises location A ID 220, which is an identity of a first approved location, geofence A 218, which may include specifications (e.g., geographic specifications, distance from center of approved location, etc.) for a geofence surrounding location A, and time constraints A 222, which may include times, days of the week, and/or specific dates that the secondary user is approved for visiting location A. Similarly, approved entry B 224 comprises location N ID 228, which is an identity of a second approved location, geofence N 226, which may include specifications (e.g., geographic specifications, distance from center of approved location, etc.) for a geofence surrounding location N, and time constraints N 230, which may include times, days of the week, and/or specific dates that the secondary user is approved for visiting location N.

Geofence A 218 and/or geofence N may have circular boundaries, non-circular boundaries and/or non-linear boundaries, and/or may be 3-dimensional (e.g., for buildings with more than one story). In some examples, an approved location entry may not have any time constraints associated with it. For example, an administrator user may allow a secondary user to be within a safe zone at any time and/or day of the week.

The group device monitoring service may track location information associated with the secondary user's computing device (e.g., device ID A 208). If the group device monitoring service determines that the secondary user is within a safe zone (e.g., within one of geofence A 218 and/or geofence N 226), the group device monitoring service may not notify and/or surface locational information to the administrator user (e.g., on an application user interface) other than to generically indicate that the secondary user is within a safe zone. However, if the group device monitoring service determines that the secondary user is outside of a safe zone, the group device monitoring service may notify and/or surface locational information to the administrator user that indicates the secondary user's current location. In some examples, if the group device monitoring service determines that the secondary user is approaching a boundary of a safe zone from the inside of the safe zone (e.g., within a threshold distance, approaching geofence boundary at a threshold speed), the group device monitoring service may alert the secondary user (e.g., via application user interface, via haptic feedback) that the secondary user is approaching the boundary of the safe zone.

Dependent location entries 232 include dependent entry B 234 and dependent entry N 244. The dependent entries comprise information for locations that an administrator user will allow the group device monitoring service to transform into fully approved locational entries (e.g., safe zones) upon the fulfillment of one or more conditions. For example, if a condition associated with a dependent entry is fulfilled, that dependent entry may be transformed into an approved locational entry.

Dependent entry B includes location B ID 238, which is an identity of a first conditional location, geofence B 236, which may include specifications (e.g., geographic specifications, distance from center of conditional location, etc.) for a geofence surrounding location B, and time constraints B 240, which may include times, days of the week, and/or specific dates that the secondary user may visit location B after dependent entry B 234 has been transformed into an approved locational entry. Dependent entry B 234 further includes visitation condition 242. Visitation condition 242 is a condition that an administrator user has placed on dependent entry B 234 that must be fulfilled before dependent entry B 234 is transformed to an approved locational entry. The condition may be that the secondary user (e.g., secondary user ID 206) visit a location corresponding to location B ID 238. For example, if a determination is made that a computing device associated with the secondary user is within a threshold distance of location B and/or within geofence B 236, visitation condition 242 may be fulfilled. In another example, the secondary user may have to visit location B a threshold number of times and/or with a threshold frequency to fulfill visitation condition 242. In another example, the secondary user may have to send an image or video taken with a computing device corresponding to device ID A 208 to an administrator user to fulfill condition 242. In additional examples, the image or video may have to include a geotag for location B to fulfill visitation condition 242. Other conditions may include visiting the location at a specific time or day of the week and/or sending an image or video from location B taken with a secondary user's computing device with a timestamp corresponding to a specific time and/or day of the week.

Similarly, dependent entry N includes location N* ID 248, which is an identity of a second conditional location, geofence N* 246, which may include specifications (e.g., geographic specifications, distance from center of conditional location, etc.) for a geofence surrounding location N*, and time constraints N*, which may include times, days of the week, and/or specific dates that the secondary user may visit location N* after dependent entry N 244 has been transformed into an approved locational entry.

Dependent entry N 244 further includes visitation condition 252. Visitation condition 252 is a condition that an administrator user has placed on dependent entry N 244 that must be fulfilled before dependent entry B 244 is transformed to an approved locational entry. The condition may be that the secondary user (e.g., secondary user ID 206) visit a location corresponding to location N* ID 248. For example, if a determination is made that a computing device associated with the secondary user is within a threshold distance of location N* and/or within geofence N* 246, visitation condition 252 may be fulfilled. In another example, the secondary user may have to visit location N* a threshold number of times and/or with a threshold frequency to fulfill visitation condition 252. In another example, the secondary user may have to send an image or video taken with a computing device corresponding to device ID A 208 to an administrator user to fulfill condition 252. In additional examples, the image or video may have to include a geotag for location N* to fulfill visitation condition 252. Other conditions may include visiting the location at a specific time or day of the week and/or sending an image or video from location N* taken with a secondary user's computing device with a timestamp corresponding to a specific time and/or day of the week.

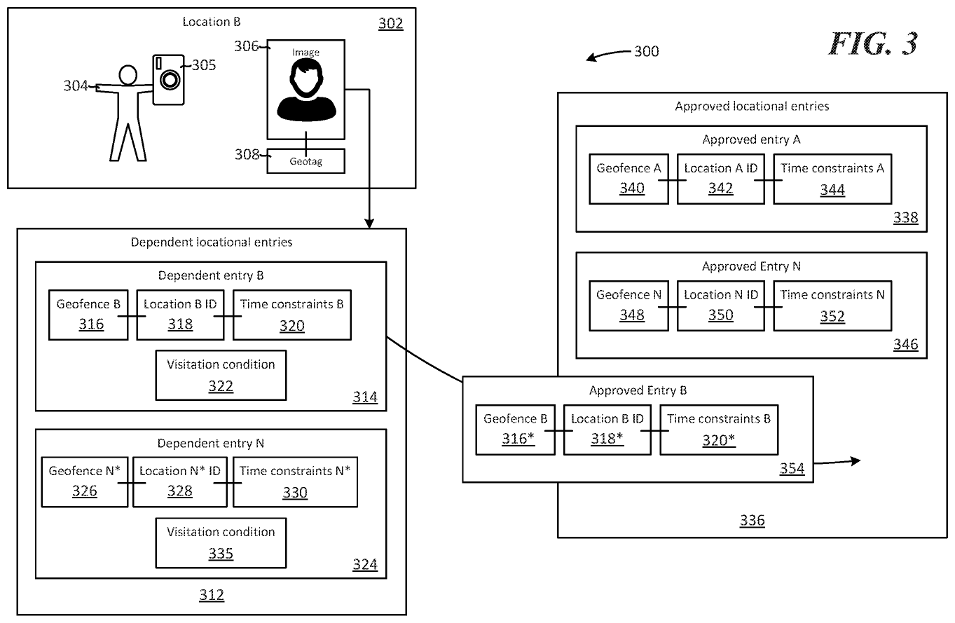

FIG. 3 illustrates a simplified block diagram of a computing environment 300 for transforming a dependent locational entry to an approved locational entry of a location control list upon the fulfillment of a locational visitation condition. Computing environment 300 includes condition fulfillment sub-environment 302, dependent locational entries 312, and approved locational entries 336. Computing environment 300 also includes approved entry B 354, which is a transformed locational entry.

Approved locational entries 336 includes two approved locational entries in a location control list for a secondary user. That secondary user is user 304 in condition fulfillment sub-environment 302. Specifically, approved locational entries 336 include approved entry A 338, which comprises geofence A 340, location A ID 342, and time constraints A 344; and approved entry N 346, which comprises geofence N 348, location N ID 350, and time constraints N 352.

Dependent locational entries 312 includes two conditional locational entries in the location control list for user 304. Specifically, dependent locational entries 312 include dependent entry B 314 and dependent entry N 324. Dependent entry B comprises geofence B 316, location B ID 318, time constraints B 320, and visitation condition 322. Dependent entry N 324 comprises geofence N* 326, location N* ID 328, time constraints N* 330, and visitation condition 335.

In this example, visitation condition 322 comprises a condition that a digital image with a geotag corresponding to location B (e.g., within a threshold distance of location B, within geofence B 316) be sent from a computing device associated with user 304 to an administrator user associated with the location control list for the secondary user. Thus, in this example, user 304 takes image 306 with computing device 305. Computing device 305 may automatically tag image 306 with a location where the image was taken. In this example, this is illustrated by geotag 308. The geotag may be within a threshold distance of location B. The threshold distance may be the boundary of geofence B 316. User 304 then sends image 306 with geotag 308 to a user account associated with the administrator user. In other examples, image 306 may be uploaded with geotag 308 to the group device management service application. Thus, user 304 may send image 306 to the administrator account via an application associated with the group device monitoring service (e.g., a “Your Family” application), and the group device monitoring service may thus determine that visitation condition 322 has been fulfilled.

Upon visitation condition 322 being fulfilled, the group device monitoring service may transform dependent entry B 314 into an approved locational entry, as illustrated by approved entry B 354. Approved entry B 354 includes geofence B 316*, location B ID 318*, and time constraints B 320*. In some examples, upon determination by the group device monitoring service that a condition, such as visitation condition 322, has been fulfilled an administrator user may have to confirm fulfillment of the condition prior the dependent entry being transformed into an approved locational entry. In other examples, upon determination by the group device monitoring service that a condition, such as visitation condition 322, has been fulfilled, the dependent entry may be automatically transformed into an approved locational entry.

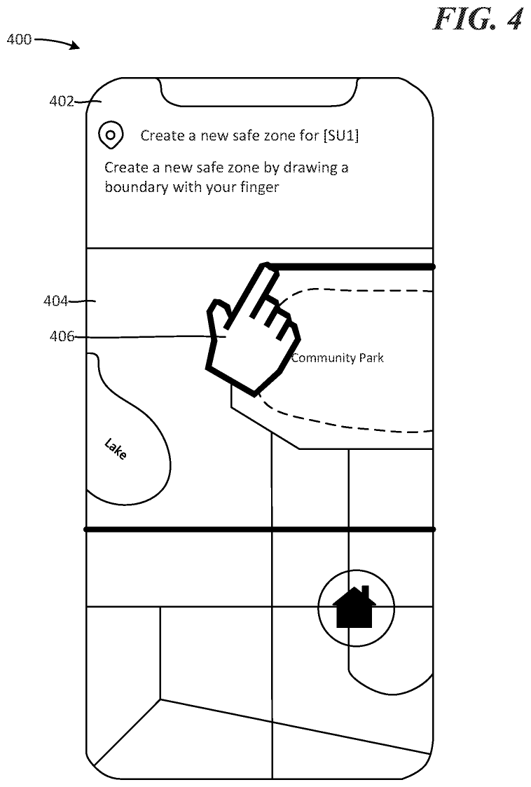

FIG. 4 illustrates a computing environment 400 for creating a new safe zone and geofence utilizing a manual boundary tracing mechanism. Computing environment 400 includes computing device 402, which is exemplary of any computing device on which a user may create a new safe zone utilizing a manual boundary tracing mechanism. The tracing mechanism may be touch-based (e.g., finger to display, stylus to display), or software based (e.g., dragging a cursor along a boundary).

Computing device 402 displays a safe zone creation screen of a group device monitoring service application (e.g., a “My Family” application). Computing device 402 may be associated with an administrator user of a group managed by the group device management service application. As such, the administrator user may have administrative controls over one or more secondary user accounts, such as the ability to create, modify, and/or delete new safe zones for the secondary user accounts.

The top of the safe zone creation screen states: “Create a new safe zone for [SU1]—Create a new safe zone by drawing a boundary with your finger”. Map 404 is displayed under the text at the top of the screen. Map 404 may have been navigated to the specific area displayed on the screen by the administrator user. In this example, the administrator user would like to create a new safe zone for the secondary user [SU1] at the community park. As such, a touch input is received tracing the boundary of the community park where the administrator user would like to create the new locational entry/safe zone. A continuous touch that creates a closed figure of any shape or size may be created utilizing the touch input and that closed figure may be automatically transformed into a locational entry. This is illustrated by touch input 406. In some examples, a geofence boundary may be automatically created at the touch input boundary of the new safe zone. In other examples, the geofence boundary may be automatically created a threshold distance from the touch input boundary of the new safe zone. In still other examples, the administrator user may manually input a distance from the touch input that the geofence will be from the touch input boundary.

The manual boundary tracing mechanism described above may be utilized to create approved locational entries and/or dependent locational entries. For example, if the administrator user wanted to create a new dependent locational entry, one or more selectable elements on the group device monitoring application may be selected for adding one or more conditions to a newly created figure for a dependent locational entry, which if satisfied, would transform the newly created dependent locational entry corresponding to the new boundary, to an approved locational entry.

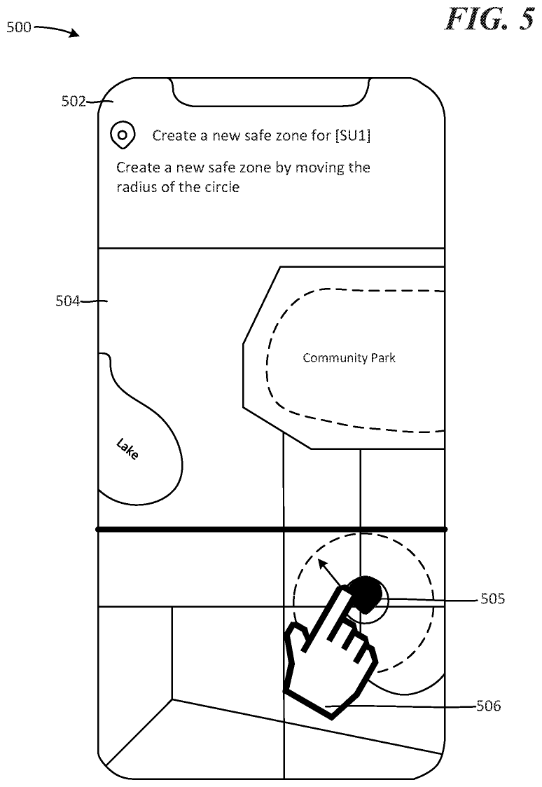

FIG. 5 illustrates a computing environment 500 for creating a new safe zone and geofence utilizing a manual radial expansion mechanism. Computing environment 500 includes computing device 502, which is exemplary of any computing device on which a user may create a new safe zone utilizing a manual radial expansion mechanism. The manual radial expansion mechanism may be touch-based (e.g., finger to display, stylus to display), or software based (e.g., clicking a border of a circle and dragging it outward).

Computing device 502 displays a safe zone creation screen of a group device monitoring service application (e.g., a “My Family” application). Computing device 502 may be associated with an administrator user of a group managed by the group device management application. As such, the administrator user may have administrative controls over one or more secondary user accounts, such as the ability to create, modify, and/or delete new safe zones for the secondary user accounts.

The top of the safe zone creation screen states: “Create a new safe zone for [SU1]—Create a new safe zone by moving the radius of the circle”. Map 504 is displayed under the text at the top of the screen. Map 404 may have been navigated to the specific area displayed on the screen by the administrator user. In this example, a user may have input an address into the group device management application, and icon 505, which marks the address on map 404 may be surfaced along with a small circle that surrounds icon 505. A user may then hold and drag or click and drag the circle outward to a desired size of a boundary for a new locational entry/safe zone. This is indicated by touch input 506. In some examples, a geofence boundary may be automatically created at the border of the circle where the radius is expanded to for the new safe zone. In other examples, the geofence boundary may be automatically created a threshold distance from the border of the circle where the radius is expanded to. In still other examples, the administrator user may manually input a distance from the border of the circle where the radius is expanded to for a geofence corresponding to the new safe zone.

The radial expansion mechanism described above may be utilized to create approved locational entries and/or dependent locational entries. For example, if the administrator user wanted to create a new dependent locational entry, one or more selectable elements on the group device monitoring application may be selected for adding one or more conditions to the newly created figure/circle for a dependent locational entry, which if satisfied, would transform the newly created dependent locational entry corresponding to the new boundary, to an approved locational entry.

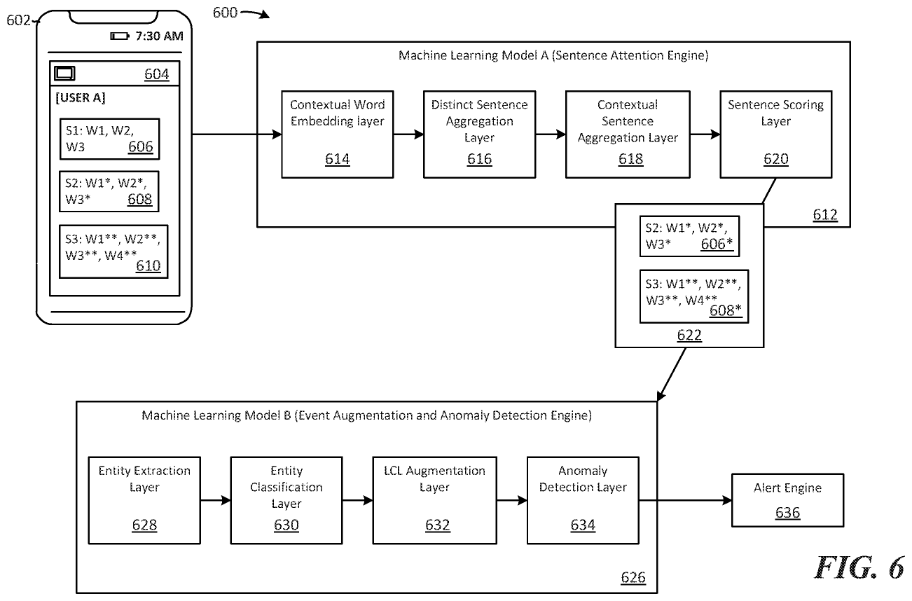

FIG. 6 illustrates a simplified block diagram 600 for processing natural language from a software application to identify new location events. Although diagram 600 illustrates the processing of natural language from a series of SMS messages, it should be understood that the described processing can be performed on natural language from various sources. For example, the processing could be performed on emails, productivity application documents, calendar events, group messaging chats, transcribed telephone conversations, and transcribed voicemails, for example.

The natural language processing described in relation to block diagram 600 may be utilized to identify locations for which new safe zones should be automatically created. For example, if a determination is made based on processing of emails and/or text messages that a secondary user is going to start attending a new school in a week, the location of the new school may be automatically added as part of a new locational entry to a location control list for that secondary user.

Diagram 600 includes smart phone computing device 602, machine learning model A 612, machine learning model B 626, extracted strings 622, and alert engine 636. Machine learning model A 612 includes contextual word embedding layer 614, distinct sentence aggregation layer 616, contextual sentence aggregation layer 618, and sentence scoring layer 620. Machine learning model A 612 receives sentences (or sentence fragments) from a natural language input, such as from messages 604. In this example, machine learning model A 612 receives language input from messages 604, which include message one 606, message two 608, and message three 610. In some examples, machine learning model A 612 may process entire messages individually. In other examples, if a message is over a threshold number of words, it may be separated into strings for processing. In still other examples, if a message includes sentences, each sentence may be processed by machine learning model A 612.

Each of messages 604 is processed by machine learning model A 612. Contextual embedding layer 614 generates an embedding for each word in each of messages 604. In generating an embedding for each word, contextual word embedding layer 614 may apply a contextual model to each of the strings included in messages 604. In examples, the contextual model that is applied may be a bidirectional encoder representations from transformers (BERT) model. In other examples, the contextual model may be a Sent2Vec model, Embeddings from Language Models (ELMo), and/or Recurrent Neural Networks model.

Distinct sentence aggregation layer 616 aggregates the embeddings for each word in messages 604 into a distinct embedding for each of the strings in messages 604. In aggregating the embeddings for each word, distinct sentence aggregation layer 616 may apply a neural network to the embeddings for each word. In examples, the neural network may comprise a gated recurrent unit (GRU) neural network or bi-GRU neural network. In other examples, the neural network may comprise a long short-term memory (LSTM) neural network.

Contextual sentence aggregation layer 618 aggregates each distinct embedding for each of the strings in messages 604 into a contextual embedding for each of the strings in messages 604. In aggregating the distinct embeddings for each string, contextual sentence aggregation layer 618 may apply a neural network to each distinct embedding for each of the strings in messages 604. In examples, the neural network may comprise a gated recurrent (GRU) neural network or bi-GRU neural network. In other examples, the neural network may comprise a long short-term memory (LSTM) neural network.

Sentence scoring layer 620 scores and ranks each of the strings in messages 604 based on their relevance to a location event intent and/or visit location intent (e.g., likelihood that a user is going to visit a new location, likelihood that a user is going to visit an existing safe zone). In scoring each of those strings, sentence scoring layer 620 may apply a classifier function to each contextual embedding for each of the plurality of strings (e.g., the embeddings generated by contextual sentence aggregation layer 618). In examples, the classifier function may comprise a sigmoid function. Other activation functions (e.g., tanh, softplus, etc.) may be utilized for scoring each sentence. In some examples, the model may be trained with a binary cross entropy loss using gold notated relevance scores. Other ways of training the model may include utilizing a margin-based hinge loss function.

According to examples, a threshold value may be utilized to determine which messages or natural language inputs to process by machine learning model B 626. For example, the values that are calculated for each of messages 604 (or strings in those messages) via sentence scoring layer 620 may be compared to a threshold value. If a string/message has a value that meets or exceeds the threshold value, that string/message may be processed by machine learning model B 626. If a string/message has a value that does not meet or exceed the threshold value, that string/message may not be processed further. The threshold value may be adjusted manually or automatically. For example, as machine learning model A 612 is trained, the threshold value may be lowered or increased. In this example, message 606* and message 608* have been determined to have met the minimum threshold and they are therefore sent to machine learning model B 626 for processing, as indicated by extracted strings 622.

Machine learning model B 626 includes entity extraction layer 628, entity classification layer 630, location control list augmentation layer 632, and anomaly detection layer 634. Entity extraction layer 628 may identify and/or extract entities that are relevant to a locational event intent and/or a visit location intent. Entity classification layer 630 may classify those entities by entity type (e.g., time, date, day of week, location, location type, etc.). Location control list augmentation layer 632 may augment a location control list, for a user account monitored by a group device monitoring service, with locational information extracted via entity extraction layer 628 and/or classified via entity classification layer 630. In some examples, if a determination is made via machine learning model A 612 that a secondary user is planning on visiting a location that is not an approved locational entry in an action control list for the secondary user account, an administrator user account may be prompted with an indication of the location, time, and/or date information associated with the determined visit. The administrator user may then approve or deny an automated request to add the location, time, and/or date as an approved locational entry to the secondary user account's location control list.

Anomaly detection layer 634 may determine whether a device associated with a user account monitored by a group device monitoring service is at a location at a time/date that is not included in a location control list for the user account. If a determination is made by anomaly detection layer 634 that a device associated with a user account monitored by a group device monitoring service is at a location at a time/date that is not included in a location control list for the user account, alert engine 636 may cause an alert to be surfaced on a computing device associated with an administrator user of the corresponding group.

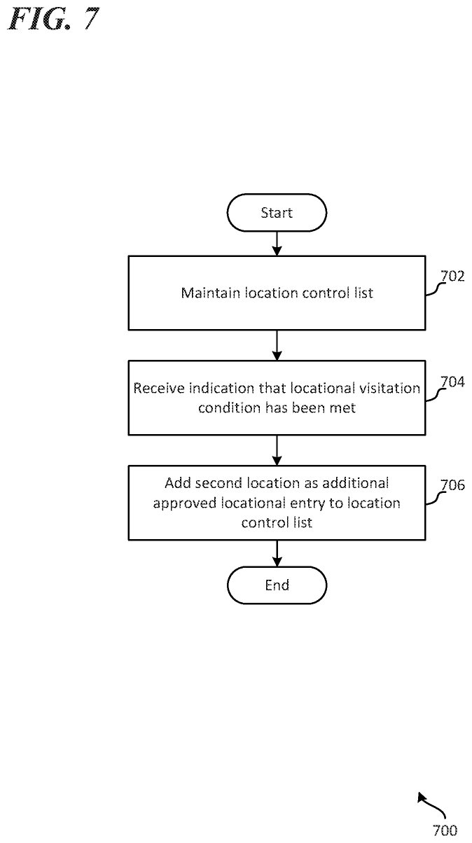

FIG. 7 is an exemplary method 700 for modifying user account locational boundaries. The method 700 begins at a start operation and flow moves to operation 702.

At operation 702 a location control list for a first user account associated with a group of a group device monitoring service is maintained. The first user account may be a secondary user account. In other examples, the first user account may be an administrator user account. The location control list may comprise an identity of a first computing device associated with the first user account, and an identity of a second computing device associated with a second user account that is an administrator of the group. The location control list may further comprise a first approved locational entry comprising geocoordinates for a first location, and a first geofence surrounding the geocoordinates for the first location. The first approved locational entry may have been manually created and/or added to the location control list, or the first approved locational entry may have been automatically created and/or added to the location control list.

The location control list may additionally comprise a dependent locational entry comprising geocoordinates for a second location, a pending location visitation condition, and a second geofence surrounding the geocoordinates for the second location. The pending location visitation condition may comprise: a condition that the first user account be determined to visit the second location a threshold number of times and/or with a threshold frequency, a condition that the first user account upload an image of the second location taken from the first computing device to the group device monitoring service, and/or a condition that the first user account upload an image of the second location taken from the first computing device with a geostamp corresponding to the second location. In some examples, the condition may comprise a requirement that an image of a specific object at the second location be taken by the first computing device and uploaded to the group device monitoring service. The group device monitoring service may apply one or more image neural networks to the image to determine whether the object is in the image.

From operation 702 flow continues to operation 704 where an indication is received, by the second user account from the first user account, that the locational visitation condition has been met. For example, the first user account may have uploaded an image of the second location taken by the first computing device to the group device monitoring service.

From operation 704 flow continues to operation 706 where the second location is added as an additional approved locational entry to the location control list.

From operation 706 flow moves to an end operation and the method 700 ends.

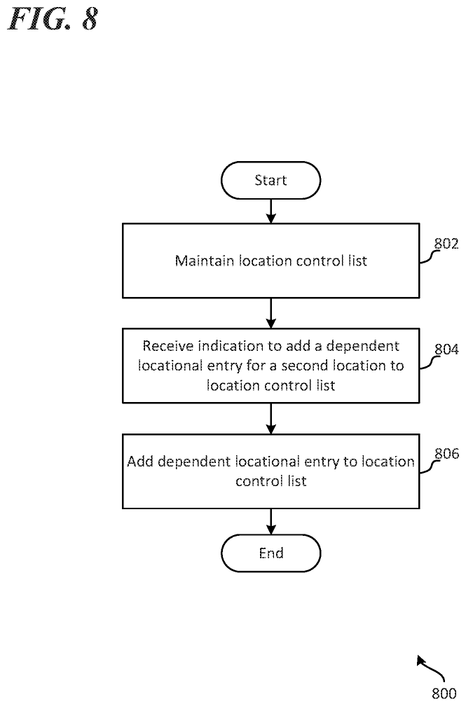

FIG. 8 is another exemplary method 800 for modifying user account locational boundaries. The method 800 begins at a start operation and flow moves to operation 802.

At operation 802 an action control list for a first user account associated with a group of a group monitoring service is maintained. The location control list may comprise an identity of a first computing device associated with the first user account and an identity of a second computing device associated with a second user account that is an administrator of the group. The first user account may be an administrator user account or a secondary user account. The location control list may further comprise a first approved locational entry comprising geocoordinates for a first location and a first geofence surrounding the geocoordinates for the first location. The first approved locational entry may have been manually or automatically created and/or added to the location control list.

From operation 802 flow continues to operation 804 where an indication to add a dependent locational entry for a second location to the location control list is received. The indication may comprise a manual input from the second user account. In other examples, the indication may be automatically generated. For example, the indication may be generated based on the first computing device having been determined to be at the second location a threshold number of times and/or with a threshold frequency. In other examples, the indication may comprise a request from the second user account to the first user account to add the second location as a location entry to the location control list.

From operation 804 flow continues to operation 806 where the dependent locational entry is added to the location control list. In some examples, the second user account may have to manually add the dependent locational entry to the location control list. In other examples, the dependent locational entry may be automatically added to the location control list. For example, the location control list may be associated with a setting (e.g., controlled by an administrator user of the group) that dictates that any time the first user account is determined to be at a location a threshold number of times, that location is automatically added as a dependent locational entry to the first user's location control list. The dependent locational entry may comprise geocoordinates for the second location, and a pending locational visitation condition.

From operation 806 flow moves to an end operation and the method 800 ends.

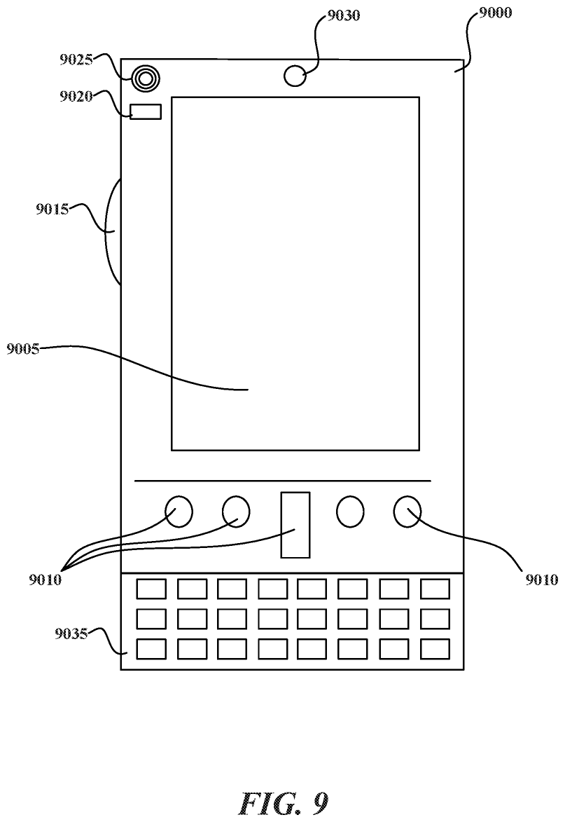

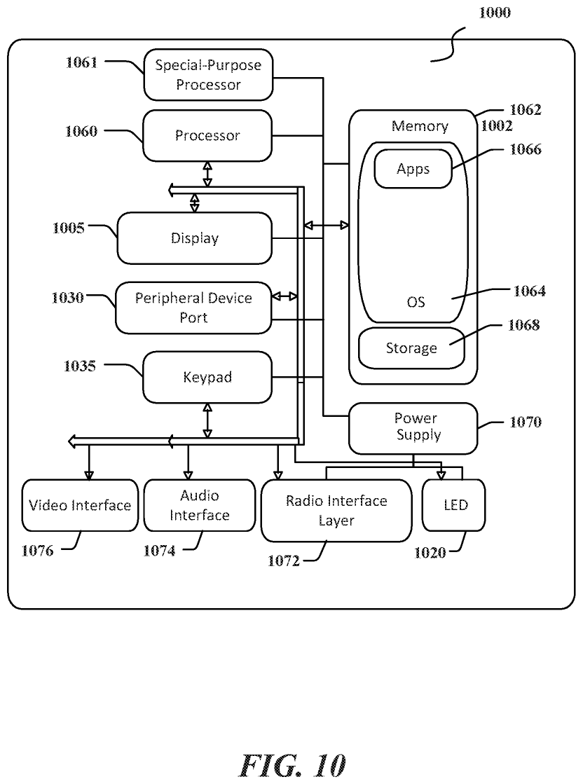

FIGS. 9 and 10 illustrate a mobile computing device 900, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 9, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or fewer input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 10 is a block diagram illustrating the architecture of one aspect of a mobile computing device. That is, the mobile computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000, including instructions for providing and operating a group device monitoring platform.

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 920 may be used to provide visual notifications, and/or an audio interface 1074 may be used for producing audible notifications via the audio transducer 925. In the illustrated embodiment, the visual indicator 920 is a light emitting diode (LED) and the audio transducer 925 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 925, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of an on-board camera 930 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10 by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

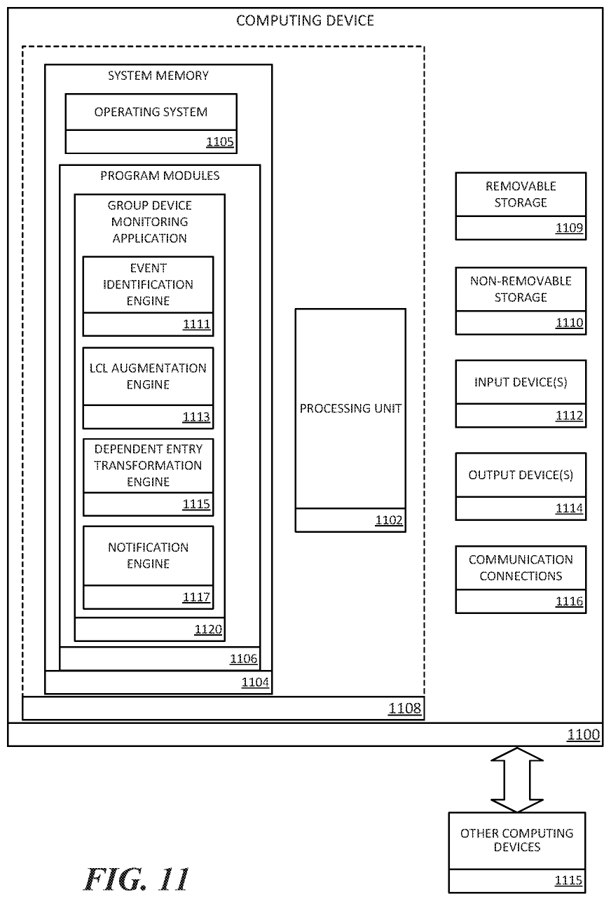

FIG. 11 is a block diagram illustrating physical components (e.g., hardware) of a computing device 1100 with which aspects of the disclosure may be practiced. The computing device components described below may have computer executable instructions for performing operations associated with a group device monitoring service as described herein. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 suitable for running one or more digital assistant programs. The operating system 1105, for example, may be suitable for controlling the operation of the computing device 1100. Furthermore, embodiments of the disclosure may be practiced in conjunction with a graphics library, other operating systems, or any other application program and is not limited to any particular application or system. This basic configuration is illustrated in FIG. 11 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., group device monitoring application 1120) may perform processes including, but not limited to, the aspects, as described herein. According to examples, event identification engine 1111 may perform one or more operations associated with applying one or more machine learning and/or natural language processing models to application data and identifying locational events from that data. LCL augmentation engine 1113 may perform one or more operations associated with adding information from identified locational events to a location control list associated with a user account monitored by a group device monitoring service. Dependent entry transformation engine 1115 may perform one or more operations associated with transforming a dependent locational entry to an approved locational entry in a location control list based on determining that one or more conditions of the dependent locational entry have been fulfilled. Notification engine 1117 may perform one or more operations associated with notifying a user that she is approaching a geofence associated with an approved locational entry in a location control list, notifying an administrator user that a secondary user is outside of safe zones associated with a location control list (e.g., providing specific location information for the secondary user), and/or notifying an administrator user that a secondary user is inside a safe zone associated with a locational control list (e.g., providing generic locational information).

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1100 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1100 may also have one or more input device(s) 1112 such as a keyboard, a mouse, a pen, a sound or voice input device, a touch or swipe input device, etc. The output device(s) 1114 such as a display, speakers, a printer, etc. may also be included. The aforementioned devices are examples and others may be used. The computing device 1100 may include one or more communication connections 1116 allowing communications with other computing devices 1150. Examples of suitable communication connections 1116 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal. Computer storage device does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

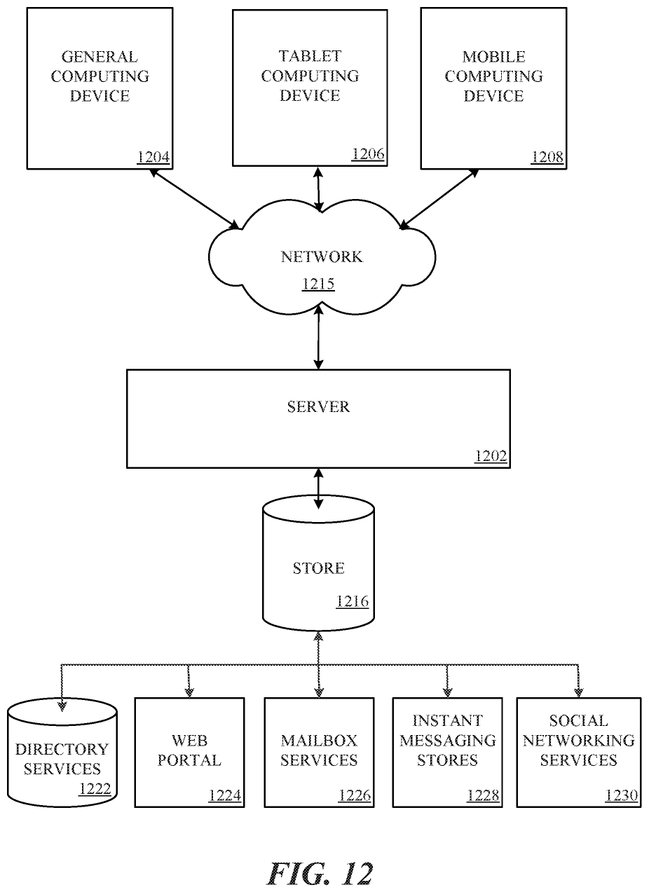

FIG. 12 illustrates one aspect of the architecture of a system for processing data received at a computing system from a remote source, such as a personal/general computer 1204, tablet computing device 1206, or mobile computing device 1208, as described above. Content displayed at server device 1202 may be stored in different communication channels or other storage types. For example, various documents may be stored using a directory service 1222, a web portal 1224, a mailbox service 1226, an instant messaging store 1228, or a social networking site 1230. The program modules 1106 may be employed by a client that communicates with server device 1202, and/or the program modules 1106 may be employed by server device 1202. The server device 1202 may provide data to and from a client computing device such as a personal/general computer 1204, a tablet computing device 1206 and/or a mobile computing device 1208 (e.g., a smart phone) through a network 1215. By way of example, the computer systems described herein may be embodied in a personal/general computer 1204, a tablet computing device 1206 and/or a mobile computing device 1208 (e.g., a smart phone). Any of these embodiments of the computing devices may obtain content from the store 1216, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method for modifying user account locational boundaries, the computer-implemented method comprising:
maintaining a location control list for a first user account associated with a group of a group device monitoring service, the location control list comprising:
an identity of a first computing device associated with the first user account,
an identity of a second computing device associated with a second user account that is an administrator of the group,
a first approved locational entry comprising geocoordinates for a first location,
a first geofence surrounding the geocoordinates for the first location,
a dependent locational entry comprising geocoordinates for a second location, and a pending locational visitation condition, and
a second geofence surrounding the geocoordinates for the second location;
receiving, by the second user account from the first user account, an indication that the locational visitation condition has been met; and
adding the second location as an additional approved locational entry to the location control list.

2. The computer-implemented method of claim 1, wherein the indication comprises a digital image of the second location.

3. The computer-implemented method of claim 2, wherein the digital image has a geotag corresponding to the geocoordinates for the second location.

4. The computer-implemented method of claim 1, further comprising:
determining that the first computing device is approaching a boundary of the first geofence from the inside of the first geofence;
sending a boundary alert to the first computing device;
determining that the first computing device has breached the boundary of the first geofence; and
sending a breach alert to the second computing device.

5. The computer-implemented method of claim 1, further comprising:
receiving an indication to check on a locational status of the first computing device;
determining whether the first computing device is within a geofence of one of a plurality of approved locational entries in the location control list; and
sending, if the first computing device is determined to be within a geofence of one of the plurality of approved locational entries in the location control list, a generic indication to the second user account that the first computing device is within an approved zone.

6. The computer-implemented method of claim 1, further comprising:
receiving an indication to check on a locational status of the first computing device;
determining whether the first computing device is within a geofence of one of a plurality of approved locational entries in the location control list; and
sending, if the first user account is determined to be outside each geofence for each of the plurality of approved locational entries in the location control list, geocoordinates corresponding to a current location of the first computing device to the second computing device.

7. The computer-implemented method of claim 1, wherein the location control list further comprises a first time when the first computing device is approved for being at the first location.

8. The computer-implemented method of claim 1, wherein the location control list further comprises a first day of a week when the first computing device is approved for being at the first location.

9. The computer-implemented method of claim 1, wherein the first approved location entry was added to the location control list based on an identified visitation pattern of the first computing device to the first location.

10. A system for modifying user account locational boundaries, comprising:
a memory for storing executable program code; and
a processor, functionally coupled to the memory, the processor being responsive to computer-executable instructions contained in the program code and operative to:
maintain an action control list for a first user account associated with a group of a group monitoring service, the location control list comprising:
an identity of a first computing device associated with the first user account,
an identity of a second computing device associated with a second user account that is an administrator of the group,
a first approved locational entry comprising geocoordinates for a first location;
a first geofence surrounding the geocoordinates for the first location;
receive an indication to add a dependent locational entry for a second location to the location control list; and
add the dependent locational entry to the location control list, the dependent locational entry comprising geocoordinates for the second location, and a pending locational visitation condition.

11. The system of claim 10, wherein the dependent locational entry further comprises a second geofence surrounding the geocoordinates for the second location.

12. The system of claim 10, wherein the processor is further responsive to the computer-executable instructions contained in the program code and operative to:
receive, by the second user account from the first user account, an indication that the locational visitation condition has been met; and
add the second location as an additional approved locational entry to the location control list.

13. The system of claim 12, wherein the indication comprises a digital image of the second location.

14. The system of claim 13, wherein the digital image has a geotag corresponding to the geocoordinates for the second location.

15. The system of claim 10, wherein the processor is further responsive to the computer executable instructions contained in the program code and operative to:
determine that the first computing device is approaching a boundary of the first geofence from the inside of the geofence;
send a boundary alert to the first computing device;
determine that the first computing device has breached the boundary of the first geofence; and
send a breach alert to the second computing device.

16. The system of claim 10, wherein the processor is further responsive to the computer-executable instructions contained in the program code and operative to:
receive an indication to check on a locational status of the first computing device;
determine whether the first computing device is within a geofence of one of a plurality of approved locational entries in the location control list; and
send, if the first computing device is determined to be within a geofence of one of the plurality of approved locational entries in the location control list, a generic indication to the second user account that the first computing device is within an approved zone.

17. The system of claim 10 wherein the first approved location entry was added to the location control list based on an identified visitation pattern of the first computing device to the first location.

18. A computer-readable storage device comprising executable instructions that, when executed by a processor, assists with modifying user account locational boundaries, the computer-readable storage device including instructions executable by the processor for:
maintaining a location control list for a first user account associated with a group of a group device monitoring service, the location control list comprising:
an identity of a first computing device associated with the first user account,
an identity of a second computing device associated with a second user account that is an administrator of the group,
a first approved locational entry comprising geocoordinates for a first location,
a first geofence surrounding the geocoordinates for the first location,
a dependent locational entry comprising geocoordinates for a second location, and a pending locational visitation condition, and
a second geofence surrounding the geocoordinates for the second location;
receiving, by the second user account from the first user account, an indication that the locational visitation condition has been met; and
adding the second location as an additional approved locational entry to the location control list.

19. The computer-readable storage device of claim 18, wherein the indication comprises a digital image of the second location.

20. The computer-readable storage device of claim 19, wherein the digital image has a geotag corresponding to the geocoordinates for the second location.
